(19) United States
(12) Patent Application Publication
(10) Pub. No.: US 2024/0030401 A1
(43) Pub. Date: Jan. 25, 2024

(54) SYSTEMS AND METHODS FOR THERMAL CURING OF WATER SOLUBLE POLYMERS FOR SILICON DOMINANT ANODES

(71) Applicant: Enevate Corporation, Irvine, CA (US)

(72) Inventors: Sanjaya D. Perera, Irvine, CA (US); Benjamin Yong Park, Irvine, CA (US); Younes Ansari, Irvine, CA (US)

(21) Appl. No.: 17/869,875

(22) Filed: Jul. 21, 2022

(51) Int. Cl. H01M 4/04; H01M 4/62; H01M 4/134

(52) U.S. Cl. CPC H01M 4/0471; H01M 4/0435; H01M 4/625; H01M 4/134; H01M 4/622; H01M 2004/027

(57) ABSTRACT

Systems and methods for thermal curing of water soluble polymers for silicon dominant anodes to improve the mechanical properties of the anode and electrochemical performance of a battery are provided.

### CROSS-REFERENCE TO RELATED APPLICATIONS/INCORPORATION BY

None.

### REFERENCE

### Field

Aspects of the present disclosure relate to energy generation and storage. More specifically, certain embodiments of the disclosure relate to systems and methods for thermal curing of water-soluble polymers for silicon dominant anodes to improve the mechanical properties of the anode and electrochemical performance of a battery.

### BACKGROUND

Conventional approaches for battery electrodes may be costly, cumbersome, and/or inefficient—e.g., they may be complex and/or time-consuming to implement, and may limit battery lifetime.

Further limitations and disadvantages of conventional and traditional approaches will become apparent to one of skill in the art, through comparison of such systems with some aspects of the present disclosure as set forth in the remainder of the present application with reference to the drawings.

### BRIEF SUMMARY

A system and/or method for thermal curing and pyrolyzation of water-based polymers to fabricate silicon-based anode materials, substantially as shown in and/or described in connection with at least one of the figures, as set forth more completely in the claims.

These and other advantages, aspects and novel features of the present disclosure, as well as details of an illustrated embodiment thereof, will be more fully understood from the following description and drawings.

### BRIEF DESCRIPTION OF SEVERAL VIEWS OF THE DRAWINGS

FIG. 1 is a diagram of a battery, in accordance with an example embodiment of the disclosure.

FIG. 2 is a flow diagram of a lamination process for forming a silicon-dominant anode cell, in accordance with an example embodiment of the disclosure.

FIG. 3 is a flow diagram of a direct coating process for forming a silicon-dominant anode cell, in accordance with an example embodiment of the disclosure.

FIG. 4 illustrates an example battery management system (BMS) for use in managing operation of batteries, in accordance with an example embodiment of the disclosure.

FIGS. 5 and 6 shows an example aqueous based PI pyrolyzed electrode produced in accordance with an example embodiment of the disclosure.

FIG. 7 shows another example anode produced in accordance with an example embodiment of the disclosure.

FIG. 8 shows yet another example anode produced in accordance with an example embodiment of the disclosure.

FIG. 9 shows a comparison with a NMP based PAI pyrolyzed anode created by a standard pyrolysis procedure without thermal curing, in accordance with an example embodiment of the disclosure.

FIGS. 10 and 11 show a performance comparison between an example aqueous based resin versus a non-cured anode, in accordance with an example embodiment of the disclosure.

The figures are not necessarily to scale. Where appropriate, similar or identical reference numbers are used to refer to similar or identical components.

### DETAILED DESCRIPTION

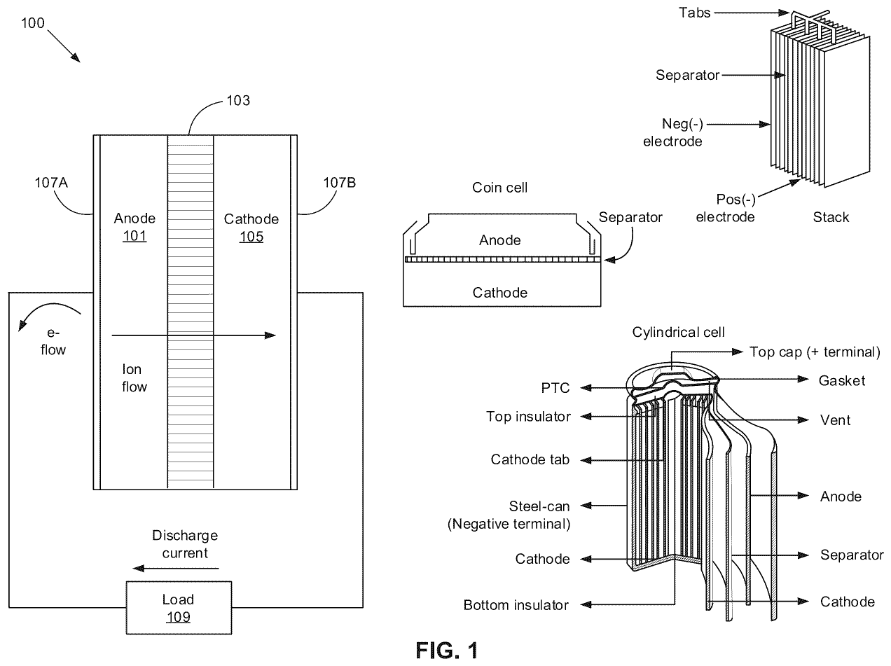

FIG. 1 illustrates an example battery. Referring to FIG. 1, there is shown a battery 100 comprising a separator 103 sandwiched between an anode 101 and a cathode 105, with current collectors 107A and 107B. There is also shown a load 109 coupled to the battery 100 illustrating instances when the battery 100 is in discharge mode. In this disclosure, the term “battery” may be used to indicate a single electrochemical cell, a plurality of electrochemical cells formed into a module, and/or a plurality of modules formed into a pack. Furthermore, the battery 100 shown in FIG. 1 is a very simplified example merely to show the principle of operation of a lithium-ion cell. Examples of realistic structures are shown to the right in FIG. 1, where stacks of electrodes and separators are utilized, with electrode coatings typically on both sides of the current collectors except, in certain cases, the outermost electrodes. The stacks may be formed into different shapes, such as a coin cell, cylindrical cell, prismatic pouch cell, or prismatic metal can cell, for example.

The development of portable electronic devices and electrification of transportation drive the need for high-performance electrochemical energy storage. In devices ranging from small-scale (<100 Wh) to large-scale (>10 kWh), Li ion batteries are widely used over other rechargeable battery chemistries due to their advantages in energy density and cyclability.

The anode 101 and cathode 105, along with the current collectors 107A and 107B, may comprise the electrodes, which may comprise plates or films within, or containing, an electrolyte material, where the plates may provide a physical barrier for containing the electrolyte as well as a conductive contact to external structures. In other embodiments, the anode/cathode plates are immersed in electrolyte while an outer casing provides electrolyte containment. The anode 101 and cathode 105 are electrically coupled to the current collectors 107A and 107B, which comprise metal or other conductive material for providing electrical contact to the electrodes as well as physical support for the active material in forming electrodes.

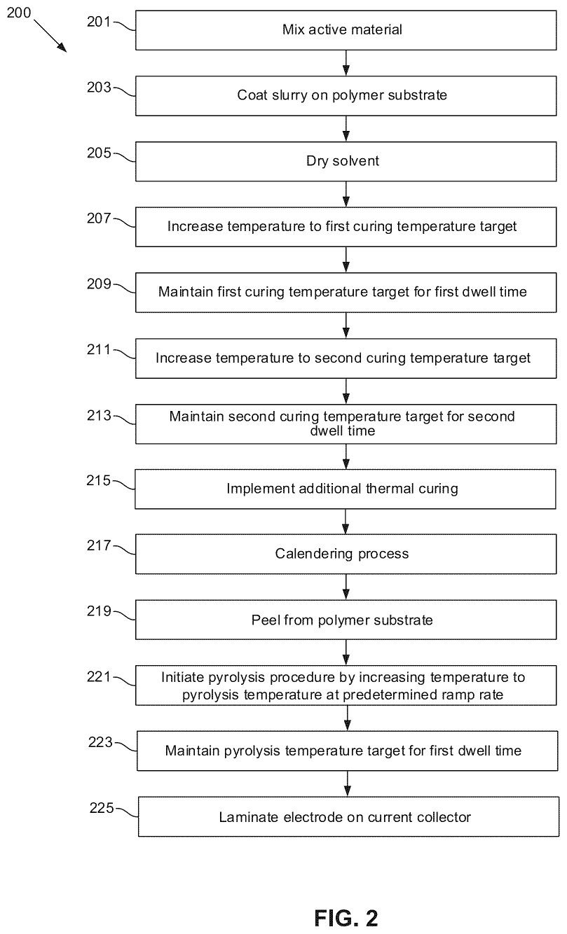

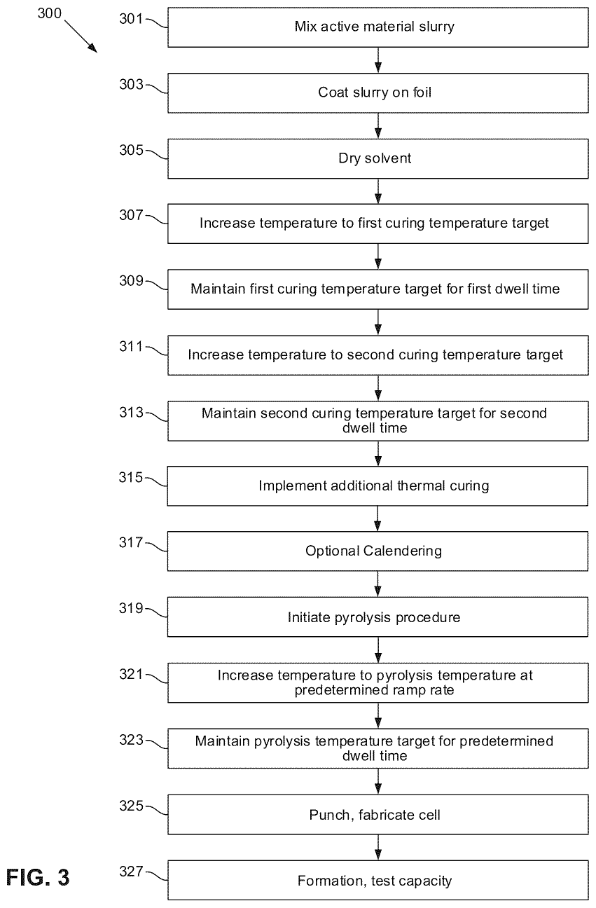

The configuration shown in FIG. 1 illustrates the battery 100 in discharge mode, whereas in a charging configuration, the load 109 may be replaced with a charger to reverse the process. In one class of batteries, the separator 103 is generally a film material, made of an electrically insulating polymer, for example, that prevents electrons from flowing from anode 101 to cathode 105, or vice versa, while being porous enough to allow ions to pass through the separator 103. Typically, the separator 103, cathode 105, and anode 101 materials are individually formed into sheets, films, or active material coated foils. In this regard, different methods or processes may be used in forming electrodes, particularly silicon-dominant (>50% in terms of active material by capacity or by weight) anodes. For example, lamination or direct coating may be used in forming a silicon-containing anode (silicon anode). Examples of such processes are illustrated in and described with respect to FIGS. 2 and 3. Sheets of the cathode, separator and anode are subsequently stacked or rolled with the separator 103 separating the cathode 105 and anode 101 to form the battery 100. In some embodiments, the separator 103 is a sheet and generally utilizes winding methods and stacking in its manufacture. In these methods, the anodes, cathodes, and current collectors (e.g., electrodes) may comprise films.

In an example scenario, the battery 100 may comprise a solid, liquid, or gel electrolyte. The separator 103 preferably does not dissolve in typical battery electrolytes such as compositions that may comprise: Ethylene Carbonate (EC), Fluoroethylene Carbonate (FEC), Propylene Carbonate (PC), Dimethyl Carbonate (DMC), Ethyl Methyl Carbonate (EMC), Diethyl Carbonate (DEC), etc. with dissolved LiBF₄, LiAsF₆, LiPF₆, and LiClO₄, LiFSI, LiTFSI, etc. In an example scenario, the electrolyte may comprise Lithium hexafluorophosphate (LiPF₆) and lithium bis(trifluoromethanesulfonyl)imide (LiTFSI) that may be used together in a variety of electrolyte solvents. Lithium hexafluorophosphate (LiPF₆) may be present at a concentration of about 0.1 to 4.0 molar (M) and lithium bis(trifluoromethanesulfonyl)imide (LiTFSI) may be present at a concentration of about 0 to 4.0 molar (M). Solvents may comprise one or more cyclic carbonates, such as ethylene carbonate (EC), fluoroethylene carbonate (FEC), or propylene carbonate (PC) as well as linear carbonates, such as ethyl methyl carbonate (EMC), diethyl carbonate (DEC), and dimethyl carbonate (DMC), in various percentages. In some embodiments, the electrolyte solvents may comprise one or more of EC from about 0-40%, FEC from about 2-40% and/or EMC from about 50-70% by weight.

The separator 103 may be soaked with a liquid or gel electrolyte. In addition, in an example embodiment, the separator 103 does not melt below about 100 to 400° C., and exhibits sufficient mechanical properties for battery applications. A battery, in operation, can experience expansion and contraction of the anode 101 and/or the cathode 105. In an example embodiment, the separator 103 can expand and contract by at least about 5 to 10% without tearing or otherwise failing, and may also be flexible.

The separator 103 may be sufficiently porous so that ions can pass through the separator once wet with, for example, a liquid or gel electrolyte. Alternatively (or additionally), the separator may absorb the electrolyte through a gelling or other process even without significant porosity. The porosity of the separator 103 is also generally not too porous to allow the anode 101 and cathode 105 to transfer electrons through the separator 103.

The anode 101 and cathode 105 comprise electrodes for the battery 100, providing electrical connections to the device for transfer of electrical charge in charge and discharge states. The anode 101 may comprise silicon, carbon, or combinations of these materials, for example. Typical anode electrodes comprise a carbon material and a current collector, such as a copper sheet. Carbon is often used because it has excellent electrochemical properties and is also electrically conductive. Anode electrodes currently used in rechargeable lithium-ion cells typically have a specific capacity of approximately 200 milliamp hours per gram (mAh/g). Graphite, the active material used in most lithium-ion battery anodes, has a theoretical energy density of 372 mAh/g. In comparison, silicon has a high theoretical capacity of 4200 mAh/g. In order to increase volumetric and gravimetric energy density of lithium-ion batteries, silicon may be used as the active material for the cathode 105 or anode 101. Si anodes may be in the form of a composite on a current collector, with >50% Si by capacity or weight in the composite layer.

In an example scenario, the anode 101 and cathode 105 store the ions used for separation of charge, such as lithium ions. In this example, the electrolyte carries positively charged lithium ions from the anode 101 to the cathode 105 in discharge mode, as shown in FIG. 1, and vice versa through the separator 103 in charge mode. The movement of the lithium ions and reactions with the electrodes create free electrons in one electrode which creates a charge at the opposite current collector. The electrical current then flows from the current collector where charge is created through the load 109 to the other current collector. The separator 103 blocks the flow of electrons inside the battery 100, allows the flow of lithium ions, and prevents direct contact between the electrodes.

While the battery 100 is discharging and providing an electric current, the anode 101 releases lithium ions to the cathode 105 through the separator 103, generating a flow of electrons from one side to the other via the coupled load 109. When the battery is being charged, the opposite happens where lithium ions are released by the cathode 105 and received by the anode 101.

The materials selected for the anode 101 and cathode 105 are important for the reliability and energy density possible for the battery 100. The energy, power, cost, and safety of current Li-ion batteries need to be improved in order to, for example, compete with internal combustion engine (ICE) technology and allow for the widespread adoption of electric vehicles (EVs). High energy density and high power density of lithium-ion batteries are achieved with the development of high-capacity and high-voltage cathodes, high-capacity anodes and electrolytes with high voltage stability and interfacial compatibility with electrodes. Functionally non-flammable or less-flammable electrolytes could be used to improve safety. In addition, materials with low toxicity are beneficial as battery materials to reduce process cost and promote consumer safety.

The performance of electrochemical electrodes, while dependent on many factors, is largely dependent on the robustness of electrical contact between electrode particles, as well as between the current collector and the electrode particles. The electrical conductivity of silicon anode electrodes may be improved by incorporating conductive additives with different morphological properties. Carbon black (Super P), vapor grown carbon fibers (VGCF), and a mixture of the two have previously been incorporated into the anode to improve electrical conductivity and otherwise improve performance. The synergistic interactions between the two carbon materials may facilitate electrical contact throughout the large volume changes of the silicon anode during charge and discharge as well as provide additional mechanical robustness to the electrode and provide mechanical strength (e.g., to keep the electrode material in place). These contact points (especially when utilizing high-aspect-ratio conductive materials) facilitate the electrical contact between anode material and current collector to mitigate the isolation (island formation) of the electrode material while also improving conductivity in between silicon regions. Graphenes and carbon nanotubes may be used because they may show similar benefits. Thus, in some instances, a mixture of two or more of carbon black, vapor grown carbon fibers, graphene, and carbon nanotubes may be used independently or in combinations for the benefits of conductivity and other performance. Some example additives include porous carbons, such as meso- or macro-carbon.

State-of-the-art lithium-ion batteries typically employ a graphite-dominant anode, which is a lithium intercalation type anode. Silicon-dominant anodes, however, offer improvements compared to graphite-dominant Li-ion batteries. Silicon exhibits both higher gravimetric (4200 mAh/g vs. 372 mAh/g for graphite) and volumetric capacities (2194 mAh/L vs. 890 mAh/L for graphite). In addition, Si has a higher redox reaction potential versus Li compared to graphite, with a voltage plateau at about 0.3-0.4V vs. Li/Li+, which allows it to maintain an open circuit potential that avoids undesirable Li plating and dendrite formation. While silicon shows excellent electrochemical activity, achieving a stable cycle life for silicon-based anodes is challenging due to silicon's large volume changes during lithiation and delithiation. Silicon regions may lose electrical contact from the anode as large volume changes coupled with its low electrical conductivity separate the silicon from surrounding materials in the anode.

In addition, the large silicon volume changes exacerbate solid electrolyte interphase (SEI) formation, which can further lead to electrical isolation and, thus, capacity loss. Expansion and shrinkage of silicon particles upon charge-discharge cycling causes pulverization of silicon particles, which increases their specific surface area. As the silicon surface area changes and increases during cycling, SEI repeatedly breaks apart and reforms. The SEI thus continually builds up around the pulverizing silicon regions during cycling into a thick electronic and ionic insulating layer. This accumulating SEI increases the impedance of the electrode and reduces the electrode electrochemical reactivity, which is detrimental to cycle life. Therefore, silicon anodes require a strong conductive matrix that (a) holds silicon particles together in the anode, (b) is flexible enough to accommodate the large volume expansion and contraction of silicon, and (c) allows a fast conduction of electrons within the matrix.

In disclosed examples, water-based anode fabrication is of interest for large scale manufacturing of anodes to reduce the cost and eliminate the use of toxic solvents. Objectives of a aqueous-based anode polymer include: 1) ease of processing—the resin being highly soluble in water allowing for ease of adjusting viscosity during coating; 2) high carbon yield and film-forming properties upon pyrolysis to create a conductive matrix around and between silicon particles; 3) a homogeneous distribution of polymeric components in water and the slurry without phase separation during the slurry formulation or coating; and 4) possessing a relatively low pyrolysis temperature that is compatible with the thermal behavior of the associated current collector. Note that aqueous-based materials are also referred to as water-based or water-soluble, these are materials that are partially or fully soluble in water or an aqueous solution.

Commercially available water-soluble polymers can have significantly low carbon yield (<10 wt. %) and develop microcracks during pyrolysis. As a result, some water-soluble polymers exhibit poor mechanical properties in the anode after pyrolysis. Polymer resins and their derivatives with high carbon yield upon pyrolysis are desired to yield a continuous carbon medium while keeping the robustness of the anode. Although available polymers and their blends may be capable of achieving a high char yield, most of these polymers are insoluble in water. Therefore, there is a trade-off among the functions of active materials, conductive additives, and polymer binders. The balance may be adversely impacted by high energy density silicon anodes with low conductivity and huge volume variations described above

Among the recent advancements in silicon-based anode development, one is the direct coated anode using organic solvent-based binders followed by heat treatment to convert the binder into a carbon matrix. However, use of binders that require organic solvents as the dissolver is problematic, as discussed above. In the present disclosure, a direct coated anode using water soluble (aqueous-based) binders followed by heat treatment to convert the binder to carbon matrix is disclosed.

The present disclosure addresses the following key advancements: 1) use of environmentally friendly solvent (water) to allow safer, cheaper and faster processing and scalability; 2) Si dominant anodes with high Si content (>70 wt. %) for high capacity; 3) the development of Si dominant anodes free of non-conducting binders capable of fast charging (>2C), i.e. anodes that contain only carbon and silicon; and introduction of a thermal curing process prior to pyrolyzation. Although solvent-based anodes have had some effectiveness in improving cycle performance, these anodes may have weak adhesion to the current collector and contain non-continued carbon media that leads to unacceptable performance.

In the present disclosure, water/aqueous-based polymer binders are employed. These polymers (also called resins) may be used as binders to fabricate silicon-based anode materials through creation of a water-based electrode slurry that is used as an electrode coating layer and further heat-treated (pyrolyzed). The polymer binder solution may also include various modifiers and/or additives in order to achieve the desired properties. The modifiers and/or additives include but are not limited to pH modifiers, viscosity modifiers, strengthening additives, surfactants and anti-foaming agents. The modifiers and/or additives may assist in any or all of, stabilizing, strengthening and/or adjusting the properties of the binder and may also serve as a carbon source themselves. The modifiers and/or additives may also apply in more than one category, for example, a compound may be a pH modifier and a viscosity modifier, etc.

Some examples are directed to implementing anode coatings using water-based slurries (aqueous-based anode) with different types and water-soluble resins. The as-coated (green) anode undergoes a pyrolysis process as the final processing step prior to punching. In some such examples, pyrolysis of the anodes were at a desired temperature (>500 deg C.) reached by a given ramp rate (e.g., between 1-10 deg C./min) followed by maintenance of the pyrolyzation temperature for a given dwell time (between 1-4 hours). This pyrolysis step played a significant role in introducing favorable electrochemical properties to the anode since the functional groups on the resin are partially or completely reduced to provide a more conductive pyrolytic carbon matrix.

Some polymers and/or resins undergo temperature-induced chemical changes, rearrangement reactions, and/or curing at certain temperatures and/or temperature ranges. As disclosed herein, incrementing through a plurality of curing temperature targets and/or maintaining the temperature targets for a predetermined dwell time allows the resin and/or other materials to complete these initial polymerization and/or rearrangement reactions before initiating a pyrolysis procedure.

Disclosed systems and methods introduce an incremental, step-wise thermal curing process and describes the effect of the thermal curing on water-soluble polyamideimide (PI) for example. As a result of the incremental thermal curing process, one or more mechanical properties and/or the electrochemical performance of the electrode (e.g., a Si anode) are improved.

Some conventional anode production involves implementing pyrolyzation and/or carbonization of the resin in the Si anodes immediately from an ambient starting temperature. This process may not allow for complete polymerization and/or curing of the resin and/or other material before pyrolyzation due to the limited amount of time the resin/materials are exposed to the polymer curing temperatures. In other words, directly and immediately implementing a pyrolyzation process may not provide adequate time for a desired reaction to complete.

To ensure a desired amount of thermal curing of the resin/materials, the present disclosure provides systems and methods for pre-polymerization of the aqueous based PI resin conducted by ramping applied temperatures to via a desired rate, thermal curing of the anodes at selected temperature targets, and/or for a desired amount of time, where polymer curing and crosslinking reactions are completed.

In some examples, there is a trade-off among the functions of active materials, conductive additives and polymer binders. The balance may be adversely impacted by high energy density silicon anodes with low conductivity and huge volume variations described above. Polymer binder(s) may be pyrolyzed to create a pyrolytic carbon matrix with embedded silicon particles. In addition, the polymers may be selected from polymers that are completely or partially soluble in water or other environmentally benign solvents or mixtures and combinations thereof. Polymer suspensions of materials that are non-soluble in water could also be utilized.

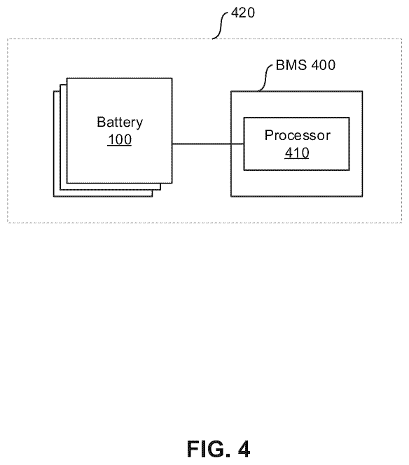

In some embodiments, dedicated systems and/or software may be used to control and manage batteries or packs thereof. In this regard, such dedicated systems may comprise suitable circuitry for running and/or executing control and manage related functions or operations. Further, such software may run on suitable circuitry, such as on processing circuitry (e.g., general processing units) already present in the systems or it may be implemented on dedicated hardware. For example, battery packs (e.g., those used in electric vehicles) may be equipped with a battery management system (BMS) for managing the batteries (or packs) and operations. An example battery management system (BMS) is illustrated in and described in more detail with respect to FIG. 4.

In the present disclosure, water-soluble (aqueous-based) polymers and methods of making anodes including such polymers are disclosed. Methods for making and using water-soluble (aqueous-based) polymers involve include, but are not limited to, one or more of the following steps: aqueous based polymer solutions for electrode preparation; preparing polymer compositions with one or more additional components such as pH modifiers, viscosity modifiers, strengthening additives, surfactants and/or anti-foaming agents using water as the solvent and the preparation of slurries with Si; and using such slurries for coating of Si dominant anode. In some embodiments, the anode is subjected to a thermal curing process followed by a high-temperature heat treatment (pyrolysis). The aqueous-based (water-soluble) polymers may be used for all different types of Si or SiOx anodes with or without a conductive (e.g. graphite) additive.

Aqueous-based (water-based) polymers (resins) useful as binders include, but are not limited to, polyimides, polyamideimides, phenolic resins (may be crosslinked), polysiloxanes, polyurethanes, polyvinyls, acrylics, polysaccharides, and derivatives thereof. The polymer binder is pyrolyzed into carbon during making of the electrode. These materials are the primary component of the binder and may function alone, or contain various additives (see below). The primary polymers (main resins) may have a carbon yield upon pyrolysis of greater than about 30%; in some embodiments the carbon yield may be 40-50% or more.

Example primary aqueous-based polymers include, but are not limited to, Polyamideimide (e.g. intl-innotek (GT-720W, GT-721W, GT-722W); China-innotek (e.g. PIW-015, PIW-025, PIW-026); Elantas (e.g. Elan-bind 1015, Elan-bind 1015 NF); Solvay Torlon AI series (e.g. AI30, AI30-LM, AI10, AI10-LM); Polyimide; Ammonium Lignosulfonate; Kraft Lignin; Phenolic resins (e.g. Plenco (Novolac Resins); Resol Resins; Polymethylol phenol; ERPENE PHENOLIC RESIN (emulsion)); Formaldehyde based Resins; Melamine-formaldehyde based resins; Silane based resins (e.g. Gelest); Silicones; Polyurethanes; Poly(vinyl acetate)/poly(vinyl alcohol) complexes; TOCRYL (acrylic emulsion); Poly(methacrylic acid); Polymethyl methacrylate; ACRONAL water-based acrylic and stryrene-acrylic emulsion polymers; STYROFAN carboxylated styrene-butadiene; Acrylic resins; Poly(acrylic acid); Glycogen; Carbohydrates; Cellulose, Cellulose crystals (including cellulose nano-crystals); HEC (Hydroxy Ethyl Cellulose); CMHEC (Carboxy methyl hydroxy ethyl cellulose); Starch; Pullulan (polysaccharide polymer); Dextran; Chitosan; Helios resins (e.g. DOMOPOL (polyester), DOMACRYL (polyacrylic), DOMALKYD (polyester) and DOMEMUL (styrene/acrylic)); and Rotaxane. Also contemplated are polymers having one or more of the following backbones: Sucrose, Glucose, Sucralose, Xylitol, Sorbitol, Sucralose, Glucosidases, Galactose, and Maltose.

FIG. 2 is a flow diagram of an example lamination process for forming a silicon-dominant anode cell. This process employs a thermal curing process, a high-temperature pyrolysis process on a substrate, layer removal, and a lamination process to adhere the active material layer to a current collector. This strategy may also be adopted by other types of anodes, such as graphite, conversion type anodes, such as transition metal oxides, transition metal phosphides, and other alloy type anodes, such as Sn, Sb, Al, P, etc.

To fabricate an anode, the raw electrode active material is mixed in step 201. In the mixing process, the active material may be mixed with a binder/resin (such as water soluble PI (polyimide), PAI (polyamideimide), carboxymethyl cellulose (CMC), styrene-butadiene rubber (SBR), poly(acrylic acid) (PAA), Sodium Alginate, Phenolic or other water soluble resins and mixtures and combinations thereof), solvent, rheology modifiers, surfactants, pH modifiers, and conductive additives. The materials may comprise carbon nanotubes/fibers, graphene sheets, metal polymers, metals, semiconductors, and/or metal oxides, for example. Silicon powder with a submicron particle size, a 1-30 or 5-30 μm particle size, or mixtures and combinations thereof, for example, may then be dispersed in polyamic acid resin, PAI, or PI (15-25% solids in N-Methyl pyrrolidone (NMP) or deionized (DI) water) at, e.g., 1000 rpm for, e.g., 10 minutes, and then the conjugated carbon/solvent slurry may be added and dispersed at, e.g., 2000 rpm for, e.g., 10 minutes to achieve a slurry viscosity within 2000-4000 cP and a total solid content of about 30-40%. The pH of the slurry can be varied from acidic to basic, which may be beneficial for controlling the solubility, conformation, or adhesion behavior of water-soluble polyelectrolytes, such as polyamic acid, carboxymethyl cellulose, or polyacrylic acid. Ionic or non-ionic surfactants may be added to facilitate the wetting of the insoluble components of the slurry or the substrates used for coating processes. The particle size and mixing times may be varied to configure the electrode coating layer density and/or roughness.

Furthermore, cathode electrode coating layers may be mixed in step 201, and coated (e.g., onto aluminum), where the electrode coating layer may comprise cathode material mixed with carbon precursor and additive as described above for the anode electrode coating layer. The cathode material may comprise Lithium Nickel Cobalt Manganese Oxide (NMC (also called NCM): LiNiₓCo_{y}Mn_{z}O₂, x+y+z=1), Lithium Iron Phosphate (LFP: LiFePO₄/C), Lithium Nickel Manganese Spinel (LNMO: e.g. LiNi_{0.5}Mn_{1.5}O₄), Lithium Nickel Cobalt Aluminum Oxide (NCA: LiNiₐCo_{b}Al_{c}O₂, a+b+c=1), Lithium Manganese Oxide (LMO: e.g. LiMn₂O₄), a quaternary system of Lithium Nickel Cobalt Manganese Aluminum Oxide (NCMA: e.g. Li[Ni_{0.89}Co_{0.05}Mn_{0.05}Al_{0.01}]O₂, Lithium Cobalt Oxide (LCO: e.g. LiCoO₂), and other Li-rich layer cathodes or similar materials, or combinations thereof. The particle size and mixing times may be varied to configure the electrode coating layer density and/or roughness.

In step 203, the slurry may be coated on a substrate. In this step, the slurry may be coated onto a polyester, polyethylene terephthalate (PET), or Mylar film at a loading of, e.g., 2-4 mg/cm 2 and then undergo thermal curing or drying in step 205 to an anode coupon with high Si content and less than 15% residual solvent content. In additional or alternative examples, one or more polymers or other materials of the slurry may be subjected to thermal curing prior to addition to the slurry.

For example, thermal curing may include incrementing through one or more curing temperature targets prior to pyrolysis. In step 207, a temperature applied to the slurry may be increased at a first rate to achieve a first curing temperature target. Once the first curing temperature target is achieved, the temperature is maintained for a first dwell time, in step 209. Following the first dwell time, the temperature applied to the slurry is increased at a second rate to achieve a second curing temperature target, in step 211. Once the second curing temperature target is achieved, the temperature is maintained for a second dwell time, in step 213.

In one or more optional steps 215, thermal curing may be further performed by increasing the applied temperature to one or more temperature targets, via one or more ramp rates. Once the one or more temperature targets are achieved, each temperature target can be maintained for a given dwell time. Thermal curing temperature targets, ramp rates, and/or dwell times are provided with respect to thermal profiles 1 to 3, presented in Tables 2-4.

This thermal curing process may be followed by an optional calendering process in step 217, where a series of hard pressure rollers may be used to finish the film/substrate into a smoothed and denser sheet of material.

In step 219, the active-material-containing film may then be removed from the PET, where the active material layer may be peeled off the polymer substrate. The peeling may be followed by a ramping of the temperature according to a predetermined ramp rate to initiate a pyrolysis procedure in step 221. Having achieved the pyrolysis temperature (e.g., 600-1250 deg C.), the material may be heated at the pyrolysis temperature for a predetermined dwell time (e.g., 1-3 hours) in step 223, cut into sheets, and vacuum dried using a two-stage process (120° C. for 15 h, 220° C. for 5 h). Temperatures, ramp rates, and/or dwell times to reach a pyrolysis temperature and implement a pyrolysis procedure are provided with respect to thermal profiles 1 to 3, presented in Tables 2-4.

The peeling process may be skipped if polypropylene (PP) substrate is used, and PP can leave ˜2% char residue upon pyrolysis.

In step 225, the electrode material may be laminated on a current collector. For example, a 5-20 μm thick copper foil may be coated with polyamide-imide with a nominal loading of, e.g., 0.2-0.6 mg/cm² (applied as a 6 wt. % varnish in NMP and dried for, e.g., 12-18 hours at, e.g., 110° C. under vacuum). The anode coupon may then be laminated on this adhesive-coated current collector. In an example scenario, the silicon-carbon composite film is laminated to the coated copper using a heated hydraulic press. An example lamination press process comprises 30-70 seconds at 300° C. and 3000-5000 psi, thereby forming the finished silicon-composite electrode.

The cell may be assessed before being subject to a formation process. The measurements may comprise impedance values, open circuit voltage, and electrode and cell thickness measurements. The formation cycles are defined as any type of charge/discharge of the cell that is performed to prepare the cell for general cycling and is considered part of the cell production process. Different rates of charge and discharge may be utilized in formation steps. During formation, the initial lithiation of the anode may be performed, followed by delithiation. Cells may be clamped during formation and/or cycling.

FIG. 3 is a flow diagram of a direct coating process for forming a silicon-dominant anode cell, in accordance with an example embodiment of the disclosure. This process comprises physically mixing the active material, conductive additive, and binder together, and coating the mixed slurry directly on a current collector before thermal curing and pyrolysis. This example process comprises a direct coating process in which an anode or cathode slurry is directly coated on a copper foil using a binder such as CMC, SBR, PAA, Sodium Alginate, PAI, PI and mixtures and combinations thereof.

In step 301, the active material may be mixed with, e.g., a binder/resin (such as PI, PAI or phenolic), solvent (such as NMP, water, other environmentally benign solvents or their mixtures and combinations thereof), and conductive additives. The materials may comprise carbon nanotubes/fibers, graphene sheets, metal polymers, metals, semiconductors, and/or metal oxides, for example. Silicon powder with a 1-30 μm particle size, for example, may then be dispersed in polyamic acid resin, PAI, PI (15% solids in DI water or N-Methyl pyrrolidone (NMP)) at, e.g., 1000 rpm for, e.g., 10 minutes, and then the conjugated carbon/solvent slurry may be added and dispersed at, e.g., 2000 rpm for, e.g., 10 minutes to achieve a slurry viscosity within 2000-4000 cP and a total solid content of about 30-40%.

Furthermore, cathode active materials may be mixed in step 301, where the active material may comprise lithium cobalt oxide (LCO), lithium iron phosphate, lithium nickel cobalt manganese oxide (NMC), lithium nickel cobalt aluminum oxide (NCA), lithium manganese oxide (LMO), lithium nickel manganese spinel, or similar materials or combinations thereof, mixed with a binder as described above for the anode active material.

In step 303, the slurry may be coated on a copper foil. In the direct coating process described here, an anode slurry is coated on a current collector with residual solvent followed by a curing or drying and a calendering process for densification. A pyrolysis step (˜500-800° C.) is then applied such that carbon precursors are partially or completely converted into glassy carbon or pyrolytic carbon. Similarly, cathode active materials may be coated on a foil material, such as aluminum, for example. The active material layer may undergo a curing or drying process in step 305 to reduce residual solvent content.

For example, thermal curing may include incrementing through one or more curing temperature targets prior to pyrolysis. In step 307, a temperature applied to the slurry may be increased at a first rate to achieve a first curing temperature target. Once the first curing temperature target is achieved, the temperature is maintained for a first dwell time, in step 309. Following the first dwell time, the temperature applied to the slurry is increased at a second rate to achieve a second curing temperature target, in step 311. Once the second curing temperature target is achieved, the temperature is maintained for a second dwell time, in step 313.

In one or more optional steps 315, thermal curing may be further performed by increasing the applied temperature to one or more temperature targets, via one or more ramp rates. Once the one or more temperature targets are achieved, each temperature target can be maintained for a given dwell time. Thermal curing temperature targets, ramp rates, and/or dwell times are provided with respect to thermal profiles 1 to 3, presented in Tables 2-4.

Following the thermal curing process, an optional calendering process may be utilized in step 317 where a series of hard pressure rollers may be used to finish the film/substrate into a smoother and denser sheet of material. In step 317, the foil and coating optionally proceeds through a roll press for calendering where the surface is smoothed out and the thickness is controlled to be thinner and/or more uniform.

In step 319, the active material may undergo a pyrolyzation procedure by heating the electrode such that carbon precursors are partially or completely converted into glassy carbon. For example, the applied temperature is ramped according to a predetermined ramp rate to initiate the pyrolysis procedure in step 321. Having achieved the pyrolysis temperature (e.g., 500-1000 deg C.), the material may be heated at the pyrolysis temperature for a predetermined dwell time (e.g., 1-3 hours) in step 323. Temperatures, ramp rates, and/or dwell times to reach a pyrolysis temperature and implement a pyrolysis procedure are provided with respect to thermal profiles 1 to 3, presented in Tables 2-4.

Pyrolysis can be done either in roll form or after punching. If the electrode is pyrolyzed in a roll form, it will be punched into individual sheets after pyrolysis. The pyrolysis step may result in an anode active material having silicon content greater than or equal to 50% by capacity or by weight. In an example scenario, the anode active material layer may comprise 20 to 95% silicon. In another example scenario may comprise 50 to 95% silicon by weight. In instances where the current collector foil is not pre-punched/pre-perforated, the formed electrode may be perforated with a punching roller, for example, in step 325. The punched anodes may then be used to assemble a cell with cathode, separator and electrolyte materials. In some instances, separator with significant adhesive properties may be utilized.

In step 327, the cell may be assessed before being subject to a formation process. The measurements may comprise impedance values, open circuit voltage, and cell and/or electrode thickness measurements. During formation, the initial lithiation of the anode may be performed, followed by delithiation. Cells may be clamped during formation and/or early cycling. The formation cycles are defined as any type of charge/discharge of the cell that is performed to prepare the cell for general cycling and is considered part of the cell production process. Different rates of charge and discharge may be utilized in formation steps.

FIG. 4 illustrates an example battery management system (BMS) for use in managing operation of batteries. Shown in FIG. 4 is battery management system (BMS) 400.

The battery management system (BMS) 400 may comprise suitable circuitry (e.g., processor 410) configured to manage one or more batteries (e.g., each being an instance of the battery 100 as described with respect with FIG. 1). In this regard, the BMS 400 may be in communication and/or coupled with each battery 100. In some implementations, a separate processor (e.g., a conventional processor, such as an electronic control unit (ECU), a microcontroller unit (ECU), or the like), or several such separate processors, may be used, and may be configured to handle algorithms or control functions with regards to the batteries. In such implementations, such processor(s) may be connected to the batteries, such as through the processor 410, and thus may be treated as part of the BMS 400 and acting as part of processor 410.

In some embodiments, the battery 100 and the BMS 400 may be in communication and/or coupled with each other, for example, via electronics or wireless communication. In some embodiments, the BMS 400 may be incorporated into the battery 100. Alternatively, in some embodiments, the BMS 400 and the battery 100 may be combined into a common package 420. Further, in some embodiments, the BMS 400 and the battery 100 may be separate devices/components, and may only be in communication with one another when present in the same system. The disclosure is not limited to any particular arrangement, however.

In accordance with disclosed examples, an anode slurry formulation for Si dominant anodes is composed of the materials provided in Table 1 to yield an electrode coating layer to coat a foil current collector (e.g., a 15 μm copper foil).

TABLE 1
Slurry Formulation (wt. %)

| Material | Weight (%) |
|---|---|
| Silicon powder | 25.37% |
| Polyimide | 5.97% |
| binder resin | |
| Water | 68.66% |

The coated anode is calendared at a predetermined temperature (e.g., 80° C.), punched and assembled into multi-layer pouch cells (e.g., 2-layer, 3-layer, 4-layer, 5-layer, etc.). As disclosed herein, these anodes are subjected to a thermal curing procedure followed by a pyrolyzation process. Both thermal curing and pyrolyzation can be conducted under an inert atmosphere, such as an Argon rich environment. Thermal curing profile was conducted to achieve the desired dwell time at different curing temperatures followed by ramping up the temperature to the pyrolyzation temperature with a dwell time prior to cooling.

The profile of the disclosed curing procedures dry the anode components to yield desirable thermal characteristics (e.g., thermal plastic, thermal set resin, crosslinking, etc.) for pyrolysis. In particular, changes to the curing procedure will change the characteristics of the anode, which can change the results of the pyrolysis process. Following the pyrolysis process, mostly C remains behind, significantly burning off the other components.

Although some specific examples are provided, the materials, temperatures, rates, times, etc., can be adjusted based on materials employed, desired characteristics of the materials (during and/or after formation of the electrode), and/or manufacturing considerations. These and other such modifications are considered within the scope of the present disclosure.

### Example-1 (Pyrolysis Following Slow Curing—Profile 1)

In an example, coated, dried anodes are subjected to a controlled thermal curing and pyrolyzation temperature profile. The temperature is ramped to one or more desired temperature targets for curing the anode (e.g., 150, 200, 250, 300, 350 degrees centigrade, deg C.). As provided in Table 1, curing temperatures are increased by a substantially similar rate (e.g., 2 deg C. per minute) to reach a subsequent temperature targets. Once a temperature target is reached, one or more such temperature targets are heated over a given dwell time (e.g., 20 minutes). For instance, different components may cure at different temperatures. Thus, for a given temperature target dwell time is selected to ensure any component that will cure at the given temperature is achieved before ramping to a subsequent temperature target.

Example ramping temperature targets, dwell times, and ramp rates are provided in Table 2. At a pyrolyzation step, anodes are heated to 650 deg C. and dwelled at this temperature target for 180 minutes, although other temperatures and/or dwell time are considered.

TABLE 2
Example 1 - Curing and Pyrolysis

| | Dwell | |
|---|---|---|
| Dwell Temperature | time | Ramp rate |
| (degC.) | (mins) | (degC./min) |
| Room Temperature (25) | | |
| Ramping to 150 | | 2 |
| 150 dwell | 20 | |
| Ramping to 200 | — | 2 |
| 200 dwell | 20 | |
| Ramping to 250 | — | 2 |
| 250 dwell | 20 | |
| Ramping to 300 | | 2 |
| 300 dwell | 20 | |
| Ramping to 350 | — | 2 |
| 350 dwell | 20 | |
| Ramping to 650 | — | 5 |
| 650 dwell | 180 | |

### Example-2 (Pyrolysis with Slow Curing—Profile 2)

In another example, coated, dried anodes are subjected to another controlled thermal curing and pyrolyzation temperature profile. As provided in Table 3, the temperature is ramped to the desired temperatures targets (e.g., 150, 200, 250, 300, 350 deg C.), each followed by a given dwell time (e.g., 20 minutes). At the final pyrolyzation step, anodes were heated to 700 deg C. with a dwell time of 180 minutes.

TABLE 3
Example 2 - Curing and Pyrolysis

| | Dwell | |
|---|---|---|
| Dwell Temperature | time | Ramp rate |
| (degC.) | (mins) | (degC./min) |
| Room Temperature (25) | | |
| Ramping to 150 | | 2 |
| 150 dwell | 20 | |
| Ramping to 200 | — | 2 |
| 200 dwell | 20 | |
| Ramping to 250 | — | 2 |
| 250 dwell | 20 | |
| Ramping to 300 | — | 2 |
| 300 dwell | 20 | |
| Ramping to 350 | — | 2 |
| 350 dwell | 20 | |
| Ramping to 700 | — | 5 |
| 700 dwell | 180 | |

### Example-3 (Pyrolysis with Rapid Curing—Profile 3)

In yet another example, coated, dried anodes are subjected to a controlled thermal curing and pyrolyzation temperature profile. As provided in Table 4, the initial temperature target (of 150 deg C.) was not maintained for any dwell time. It may be advantageous to accelerate ramping to higher temperatures, as a limited amount of curing is expected at lower temperatures.

In this example, a number of subsequent temperature targets of the curing process (e.g., from 200 to 250 and to 300 to 350 deg C.) are ramped at a rate of 2 deg C. per minute, followed by a similar dwell time (e.g., 20 minutes). However, ramping from the penultimate temperature target (e.g., 300 deg C.) of the curing procedure to the final curing procedure temperature target (e.g., 350 deg C.) is increased to a rate of 5 deg C. per minute, following by a 20 minute dwell time. The curing and pyrolysis profile progresses to a pyrolysis procedure, by a ramp rate of 5 deg C. per minute to a pyrolysis temperature target of 650 deg C. At the final pyrolyzation step, the anode is heated at 650 deg C. for a dwell time of 180 minutes.

TABLE 4
Example 3 - Curing and Pyrolysis

| | Dwell | |
|---|---|---|
| Dwell Temperature | time | Ramp rate |
| (degC. | (mins) | (degC./min) |
| Room Temperature (25) | | |
| Ramping to 150 | | 2 |
| 150 dwell | 0 | |
| Ramping to 200 | — | 2 |
| 200 dwell | 20 | |
| Ramping to 250 | — | 2 |
| 250 dwell | 20 | |
| Ramping to 300 | — | 2 |
| 300 dwell | 20 | |
| Ramping to 350 | — | 5 |
| 350 dwell | 20 | |
| Ramping to 650 | — | 5 |
| 650 dwell | 180 | |

The anode slurry (according to the example formulation of Table 1) has a viscosity of 2500 centipoise (cP) at room temperature (e.g., 25 deg C.). The PI resin first undergoes thermal curing (according to the example thermal profiles provided in Tables 2-4), and forms a mechanically stable carbon structure. At the pyrolysis stage, the cured PI resin is converted to the primary pyrolytic carbon source for the silicon composite matrix.

Anodes where the slurry formation is thermally cured prior to pyrolysis exhibit improved mechanical properties. To validate the flexibility of anodes thermally cured prior to pyrolysis (e.g., at temperatures following the thermal profiles provided in Tables 2-4), the anodes were tested using a 2 mm mandrel test. For example, anodes were sandwiched between two papers and rolled tightly at a controlled speed and visually checked for cracks on the anodes and/or copper exposure from the foil current collector. MSK-112A Winding Machine from MTI was used for this evaluation.

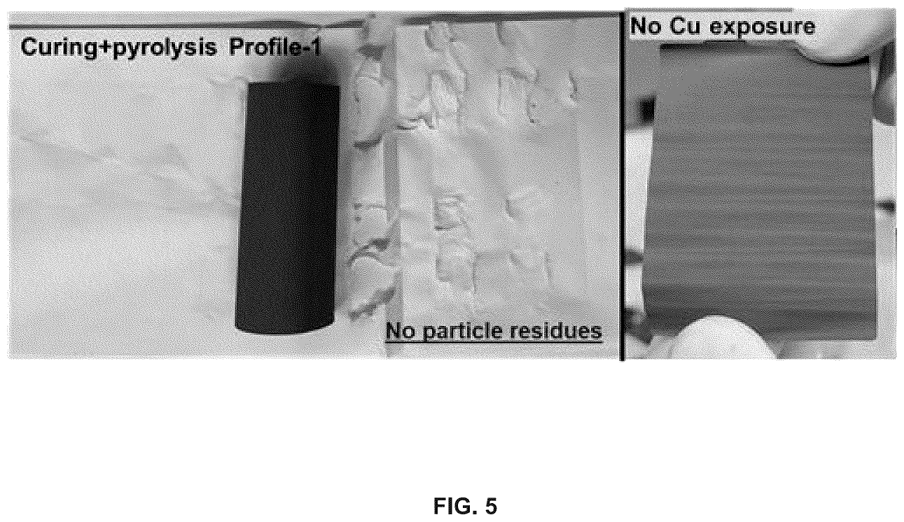

As shown in FIGS. 5-9, anodes that were thermally cured prior to pyrolyzation exhibit improved adherence to the copper current collector. Table 5 provides quantitative analysis and comparison of the flexibility of the anodes that were thermally cured under thermal profiles 1-3. As shown in Table 5, thermal curing and pyrolysis profile 1 and 2 exhibits enhanced flexibility, even in comparison to profile 3 (e.g., rapid curing). Generally, lower values reflect improved flexibility.

The bend test value is a combination of observed copper exposure, flaking, and cracks appeared during the bend test using, for example, a 4 mm and 2 mm mandrel wherein a lower score demonstrates a better bendability. The adhesion of the anode material was evaluated by applying a constant force vertical to the sample using a tape. Adhesion of the anodes (e.g., produced via thermal profiles 1-3) are similar, (e.g., greater than 200 g).

TABLE 5
Quantitative measurements for the bending test for the anodes.

| | Cracks | Cu Exposed, | Flaking, | Bend Test | Cracks, | Cu Exposed, | Flaking, | Bend Test |
|---|---|---|---|---|---|---|---|---|
| | 4 mm | 4 mm | 4 mm | Score | 2 mm | 2 mm | 2 mm | Score |
| Sample | (0, 0.5, 1) | (0, 0.5, 1) | (0, 0.5, 1) | 4 mm Rod | (0, 0.5, 1) | (0, 0.5, 1) | (0, 0.5, 1) | 2 mm Rod |
| Standard | 1 | 0.5 | 0.5 | 6 | | | | |
| Profile-1 | 0.5 | 0 | 0 | 1.5 | 1 | 0.5 | 0.5 | 2 |
| Profile-2 | 0.5 | 0 | 0 | 1.5 | 1 | 0.5 | 0.5 | 2 |
| Profile-3 | 1 | 0 | 0.5 | 4.5 | 1 | 0.5 | 0.5 | 2 |

Tape tests are measured by applying individual 10 g weights to the anode at a 90 degree angle until the anode composite layer detaches from the copper foil. In some examples, a ¾ inch wide 3M Scotch® tape is used in this test.

Bend scores are derived from the winding test, where the score is from a combination of experimental observations, including, but not limited to, flaking of the composite layer, exposure of copper of the current collector, and/or cracking of the composite layer. The test is administered by rolling the anode about a rod with diameters of 4 mm and 2 mm, for example, as shown in table 5. A lower score value indicates better flexibility, and is indicative of better adhesion between the composite layer and the current collector.

### Bend Test Criteria/Scoring Specification

TABLE 6
Bend Test Criteria, Scoring Specification

| Categories | Description/Level | Value | Comments |
|---|---|---|---|
| Rod (Rd) | 2 mm, mandrel diameter | 2 | Start with 4 mm rod. If the calculated |
| | 4 mm, mandrel diameter | 4 | score is <3, continue to 2 mm rod. |
| Cracks (Cr) | None | 0.0 | Score Equation: |
| | Yes, no line on separator | 0.5 | Score = (Rd − 1)(Cr + Cu +Fl) |
| | Yes, lines on separator | 1.0 | Score 10 if Unable to perform test due |
| Copper | None | 0.0 | to electrode pulverizing/delaminating |
| Exposed | Yes, barely or only along cracks | 0.5 | just by the necessary light handling to |
| (Cu) | Yes, clearly | 1.0 | perform test. |
| Flaking (Fl) | None | 0.0 | |
| | Powder residue on separator | 0.5 | |
| | Delaminated particles | 1.0 | |

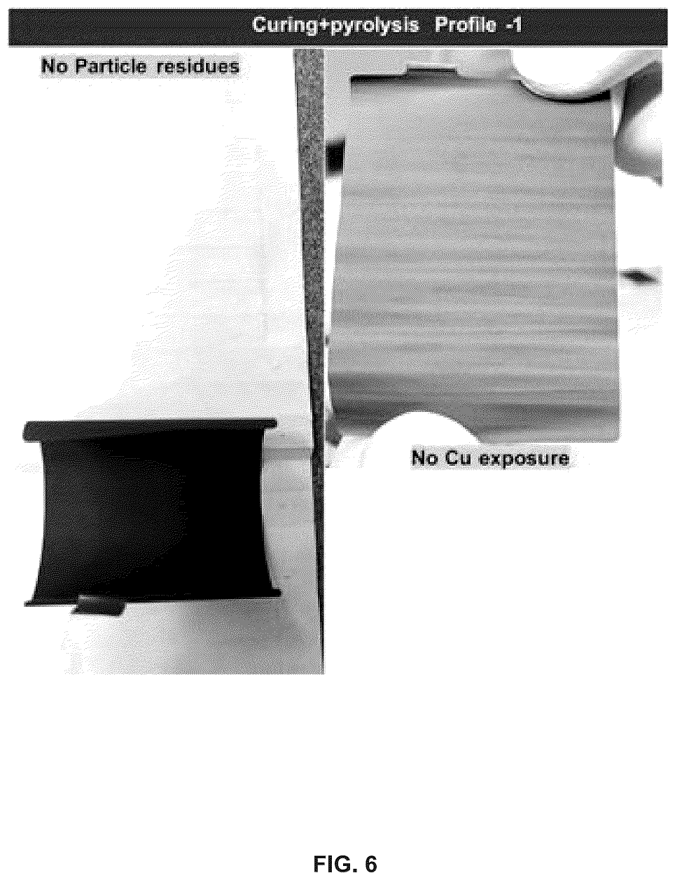

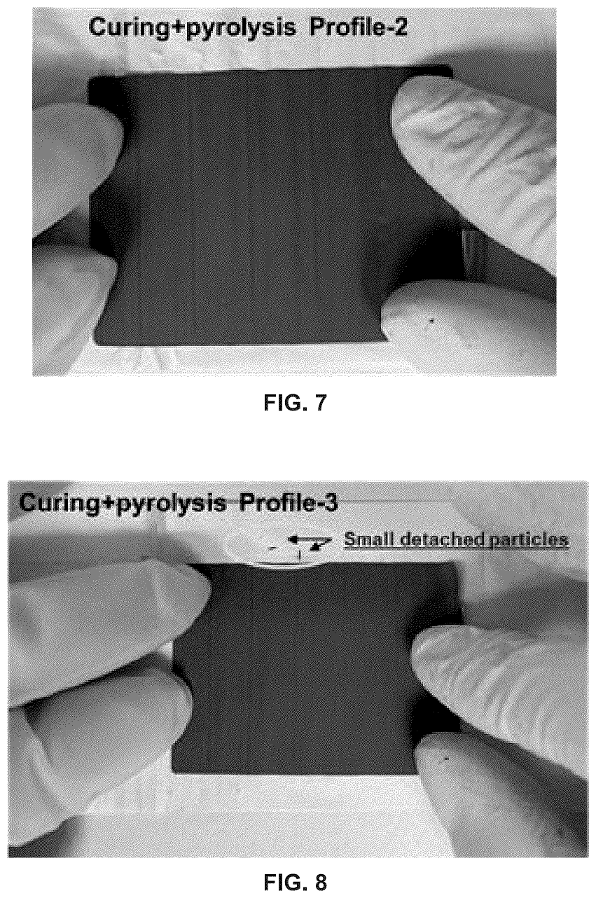

As shown in FIGS. 5 and 6, an aqueous based PI pyrolyzed electrode produced in accordance with profile 1 presents no particle residue or copper exposure. FIG. 7 shows an anode produced in accordance with profile 2, and similarly presents no particle residue. FIG. 8 shows an anode produced in accordance with profile 3, which does present small, detached particles. These results correlate to the analysis provided in Table 5.

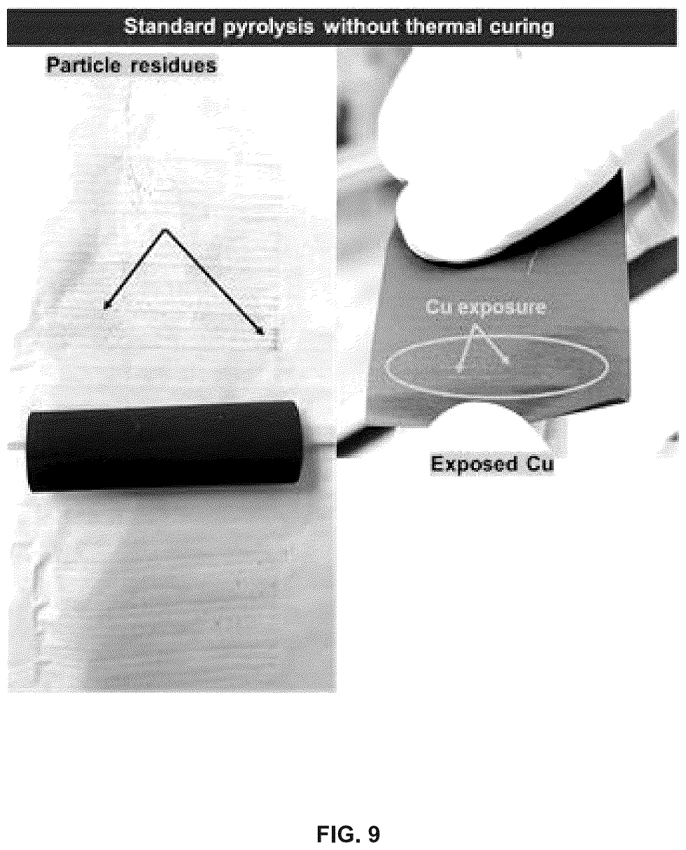

FIG. 9 shows a comparison with a NMP based PAI pyrolyzed anode created by a standard pyrolysis procedure without thermal curing. As shown, particle residue is presented on paper, as well as copper exposure from the underlying current collector. This degraded performance stands in contrast to the aqueous based PI pyrolyzed anode created via thermal profile 1 shown in FIG. 5.

The results provided in Table 5 and validated in FIGS. 5-9 indicate that PI polymer benefits from a curing profile generally, and further benefits from a slow curing profile. By implementing a slow curing process, an anode exhibits improved mechanical integrity after pyrolysis.

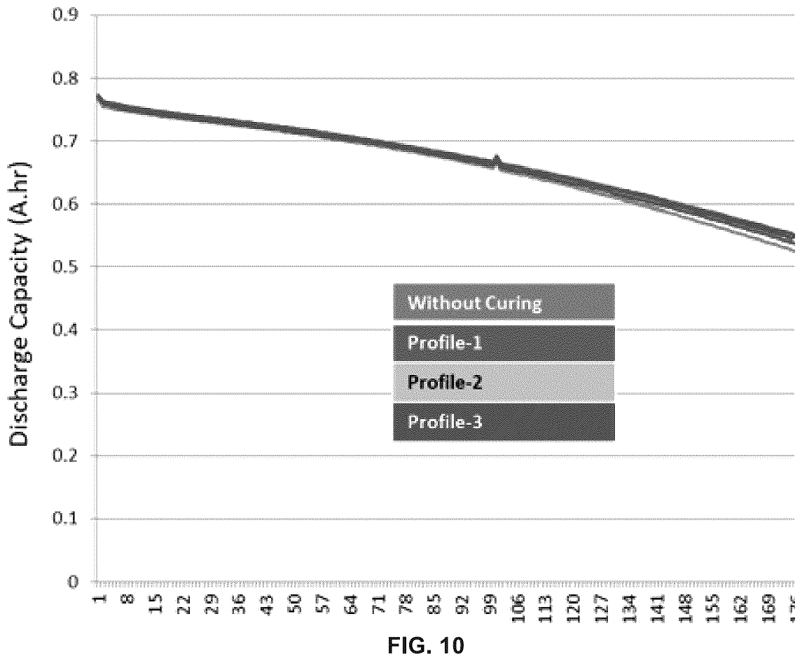

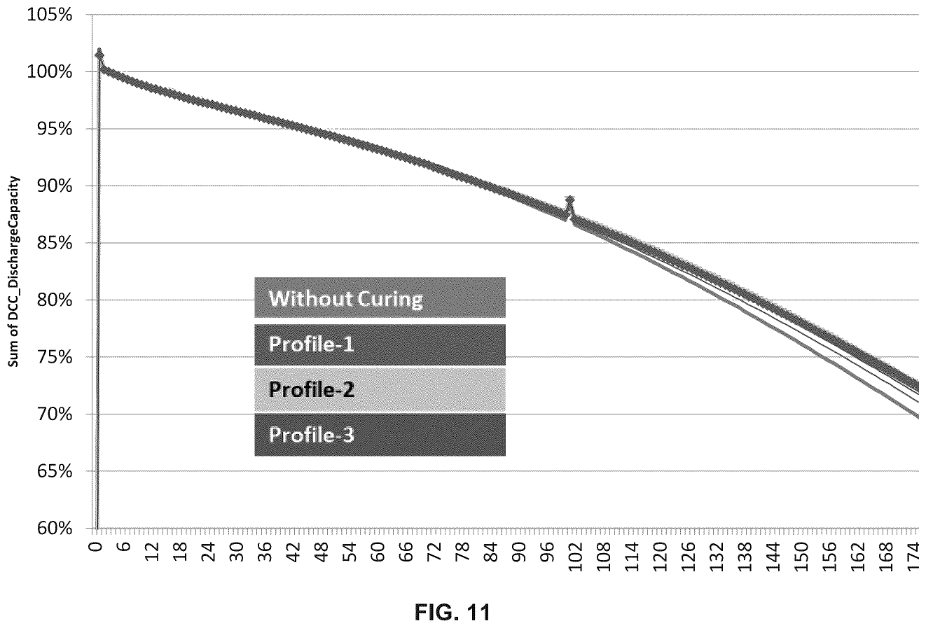

FIGS. 10 and 11 compare performance of the aqueous based PI resin (e.g., slurry formulation of Table 1) versus a non-cured, NMP based PAI anode. For instance, anodes prepared via curing and pyrolysis thermal profiles 1-3 have been tested in multi-layer (e.g., a 5-layer) pouch cells to evaluate the effect of the thermal curing on the electrochemical performance. FIGS. 10 and 11 show the cycling performance of the anodes treated with thermal profiles 1-3 were tested at 2C (4.2V)-0.5C (2.75V) at a standard temperature (e.g., 25 deg C.). As shown in the figures, introduction of thermal curing did not substantially alter cycling performance of the battery, which, as described herein, improves the mechanical properties of the anode without compromising anode cycling performance.

Table 6 provides average resistivity values of anodes treated at different thermal curing and pyrolysis profiles 1-3. For example, resistivity of a standard anode electrode (e.g., formed without the disclosed thermal curing profiles) is compared against resistivity of electrodes formed using the curing and pyrolysis thermal profiles 1-3. The resistivity of the anodes are measured by sandwiching the anode between two blocking electrodes with a diameter of 0.01 m and area of 7.85E-5 m2.

As provided in Table 6, resistivity of the anodes having undergone the various thermal curing and pyrolysis profiles show significant improvement over standard anodes. For example, anodes pyrolyzed using Profile 1 showed the lowest resistivity.

TABLE 6
Average through resistance values

| Thermal | Resistivity |
|---|---|
| Profile | (Ω · m) |
| Standard | 2.59 |
| Profile-1 | 0.75 |
| Profile-2 | 1.98 |
| Profile-3 | 4.57 |

In disclosed examples, a method of forming an electrode includes creating an electrode coating layer from an electrode slurry comprising silicon and a polymer; fabricating a battery electrode by coating the slurry on a current collector; increasing a temperature applied to the slurry incrementally over a plurality of curing temperature targets; maintaining each curing temperature target for a predetermined dwell time; and increasing to a pyrolyzation temperature from the curing temperature target to yield a stable carbon matrix in a mechanically stable electrode structure.

In some examples, the plurality of curing temperature targets is less than 300 degrees centigrade. In some examples, the pyrolyzation temperature is greater than 400 degrees centigrade.

In some examples, incrementally increasing the plurality of curing temperature targets comprises increasing a temperature applied to the anode to a first curing temperature target of the plurality of curing temperature targets by a first temperature ramp rate. In examples, the method includes increasing the temperature applied to the anode from the first curing temperature target to a second curing temperature target of the plurality of curing temperature targets by a second temperature ramp rate.

In examples, the method includes increasing the temperature applied to the anode from the second curing temperature target to a third curing temperature target of the plurality of curing temperature targets by a third temperature ramp rate.

In some examples, the first and second temperature ramp rates are the same. In some examples, the first temperature ramp rate is less than the second temperature ramp rate.

In some examples, the method further includes maintaining each curing temperature target for the predetermined dwell time comprises the first curing temperature target for a first dwell time. In examples, the method further includes maintaining the second curing temperature target for a second dwell time.

In some examples, the first and second dwell times are the same. In some examples, the first dwell time is less than the second dwell time.

In some examples, the method further includes maintaining the pyrolyzation temperature for a third dwell time. In some examples, the polymer is an aqueous-based polymer.

In some disclosed examples, a method of forming an electrode includes creating an electrode coating layer from an electrode slurry comprising silicon and a polymer; fabricating a battery electrode by coating the slurry on a current collector; increasing temperature applied to the slurry to a first curing temperature target; maintaining the first curing temperature target for a first dwell time; increasing the temperature applied to the slurry to a second curing temperature target; maintaining the second curing temperature target for a second dwell time; and increasing the temperature applied to the slurry to a pyrolyzation temperature to yield a stable carbon matrix in a mechanically stable electrode structure.

In some examples, creating the electrode coating layer further includes a conductive additive.

In some examples, the conductive additive comprises one or more of carbon black, graphite, graphene, carbon nanofibers, carbon microfibers, carbon nanotubes, porous carbons, one-dimensional carbon materials, two-dimensional carbon materials, or three-dimensional carbon materials.

In some examples, creating the electrode coating layer further includes a solvent selected from one or more of organic solvents, aqueous solvents, and organic-aqueous binary solvent systems.

In some examples, the polymer includes an aqueous-based polymer or a secondary polymer selected from a decomposable functional group including one or more of —OH, NH—, NH2, and —COOH at a relatively low temperature.

In some examples, the temperature is applied from one or more energy delivery sources including a thermal energy source, an Ultra-Violet (UV), and chemical heating agent.

As utilized herein the terms “circuits” and “circuitry” refer to physical electronic components (i.e. hardware) and any software and/or firmware (“code”) which may configure the hardware, be executed by the hardware, and or otherwise be associated with the hardware. As used herein, for example, a particular processor and memory may comprise a first “circuit” when executing a first one or more lines of code and may comprise a second “circuit” when executing a second one or more lines of code. As utilized herein, “and/or” means any one or more of the items in the list joined by “and/or”. As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y and/or z” means “one or more of x, y and z”. As utilized herein, the term “exemplary” means serving as a non-limiting example, instance, or illustration. As utilized herein, the terms “e.g.,” and “for example” set off lists of one or more non-limiting examples, instances, or illustrations. As utilized herein, a battery, circuitry, or a device is “operable” to perform a function whenever the battery, circuitry, or device comprises the necessary hardware and code (if any is necessary) or other elements to perform the function, regardless of whether performance of the function is disabled or not enabled (e.g., by a user-configurable setting, factory trim, configuration, etc.).

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method of forming an electrode, the method comprising:
creating an electrode coating layer from an electrode slurry comprising silicon and a polymer;
fabricating a battery electrode by coating the slurry on a current collector;
increasing a temperature applied to the slurry incrementally over a plurality of curing temperature targets;
maintaining each curing temperature target for a predetermined dwell time; and
increasing to a pyrolyzation temperature from the curing temperature target to yield a stable carbon matrix in a mechanically stable electrode structure.

2. The method of claim 1, wherein the plurality of curing temperature targets is less than 300 degrees centigrade.

3. The method of claim 1, wherein the pyrolyzation temperature is greater than 400 degrees centigrade.

4. The method of claim 1, wherein incrementally increasing the plurality of curing temperature targets comprises increasing a temperature applied to the anode to a first curing temperature target of the plurality of curing temperature targets by a first temperature ramp rate.

5. The method of claim 4, further comprising increasing the temperature applied to the anode from the first curing temperature target to a second curing temperature target of the plurality of curing temperature targets by a second temperature ramp rate.

6. The method of claim 5, further comprising increasing the temperature applied to the anode from the second curing temperature target to a third curing temperature target of the plurality of curing temperature targets by a third temperature ramp rate.

7. The method of claim 5, wherein the first and second temperature ramp rates are the same.

8. The method of claim 5, wherein the first temperature ramp rate is less than the second temperature ramp rate.

9. The method of claim 5, wherein maintaining each curing temperature target for the predetermined dwell time comprises the first curing temperature target for a first dwell time.

10. The method of claim 9, further comprising maintaining the second curing temperature target for a second dwell time.

11. The method of claim 10, wherein the first and second dwell times are the same.

12. The method of claim 10, wherein the first dwell time is less than the second dwell time.

13. The method of claim 10, further comprising maintaining the pyrolyzation temperature for a third dwell time.

14. The method of claim 13, wherein the polymer is an aqueous-based polymer.

15. A method of forming an electrode, the method comprising:
creating an electrode coating layer from an electrode slurry comprising silicon and a polymer;
fabricating a battery electrode by coating the slurry on a current collector;
increasing temperature applied to the slurry to a first curing temperature target;
maintaining the first curing temperature target for a first dwell time;
increasing the temperature applied to the slurry to a second curing temperature target;
maintaining the second curing temperature target for a second dwell time; and
increasing the temperature applied to the slurry to a pyrolyzation temperature to yield a stable carbon matrix in a mechanically stable electrode structure.

16. The method of claim 15, wherein creating the electrode coating layer further comprises including a conductive additive.

17. The method of claim 16, wherein the conductive additive comprises one or more of carbon black, graphite, graphene, carbon nanofibers, carbon microfibers, carbon nanotubes, porous carbons, one-dimensional carbon materials, two-dimensional carbon materials, or three-dimensional carbon materials.

18. The method of claim 15, wherein creating the electrode coating layer further comprises including a solvent selected from one or more of organic solvents, aqueous solvents, and organic-aqueous binary solvent systems.

19. The method of claim 15, wherein the polymer comprises an aqueous-based polymer or a secondary polymer selected from a decomposable functional group including one or more of —OH, NH—, NH₂, and —COOH at a relatively low temperature.

20. The method of claim 15, wherein the temperature is applied from one or more energy delivery sources including a thermal energy source, an Ultra-Violet (UV), and chemical heating agent.
